(19) United States
(12) Patent Application Publication
(10) Pub. No.: US 2023/0058062 A1
(43) Pub. Date: Feb. 23, 2023

(54) ARTICULATED DISPOSABLE RESTRAINING DEVICE

(71) Applicant: UNITED TERRA TECHNOLOGIES LLC, Dunedin, FL (US)

(72) Inventor: Timothy L. Pelkey, Fitzwilliam, NH (US)

(21) Appl. No.: 17/887,472

(22) Filed: Aug. 14, 2022

Related U.S. Application Data
(60) Provisional application No. 63/235,294, filed on Aug. 20, 2021.

(51) Int. Cl. E05B 75/00

(52) U.S. Cl. CPC E05B 75/00

(57) ABSTRACT

In one aspect, a disposable restraint comprises two individual semi-rigid toothed straps, each strap including a head member and a tail member, wherein each head member includes a slot with a toothed socket clasp therein; and wherein the two straps are joined together at the head members thereby forming an articulating joint. In further aspects, methods for forming an articulated disposable handcuff are provided.

### CROSS REFERENCE TO RELATED APPLICATION

This application claims the priority benefit of U.S. provisional application Ser. No. 63/235,294 filed Aug. 20, 2021. The aforementioned application is incorporated herein in its entirety.

### BACKGROUND

The present disclosure relates to disposable restraints, particularly of the double loop variety. The restraints advantageously find utility as wrist/handcuff restraints for use by law enforcement personnel and will be described herein primarily by way of reference thereto. However, although it will be recognized that the restraint device disclosed herein are equally amenable for use as ankle/foot restraints. Existing disposable handcuffs are bulky products and would find more use by police and other security personnel if they could be carried in a more convenient manner.

Temporary police restraints are those which are used once and disposed of after use. The restraint is typically made of a semi-rigid polymeric material such as nylon with a permanent locking head. See, for example, U.S. Pat. No. 5,193,254, the entire disclosure of which is incorporated herein by reference.

Typically, in order to release such restraints, the straps are cut apart, as otherwise the straps cannot be manually released from the locked engagement with the head. Temporary restraints of this type have been used for many years and in many forms, both as a single loop restraint and in recent years as a double loop restraint. See for example U.S. Pat. Nos. 4,910,831, 5,159,728, and 5,398,383, the disclosures of which are incorporated herein by reference in their entireties.

Bingold, in U.S. Pat. No. 5,159,728, teaches a semi-rigid disposable cuff in which the straps can be inserted into two non-locking apertures located in the central head member, thereby forming one or more loose loops. The head apertures are only wide enough to permit a single passage of the straps therethrough.

Double loop cuffs are typically made from two elongated, substantially flat straps having a toothed socket clasp located at the midpoint. The cuffs are used by inserting the free end(s) into the opening(s) in the socket clasp. The strap(s) also have a toothed surface, and the teeth allow forward movement, which makes the loop(s) smaller and tighter, but do not permit withdrawal of the strap(s) from the clasp(s).

The problem with such temporary restraints, especially of the double loop type, is that they are very bulky, and are thus awkward to store and carry. The cuffs are a semi-rigid, substantially unbreakable polymeric material that generally lies flat, typically extending from about 26 to 38 inches in length for the double cuffs. The police officer needs to have ready availability of these restraints when they are needed. Often such restraints are employed in crowd and/or riot situations, where a number of such restraints are required. Disposable restraints would be much more useful if the police officers could carry a number of the restraints on their person in a convenient manner.

Some manufacturers have tried to solve the bulkiness problem by making one or more “folds” or using hinges in the cuffs, thereby allowing the cuffs to be carried in a more compact manner. See for example the ASP Tri-fold cuff, available from Armament Systems & Procedures, Appleton, Wis. The ASP cuff is shown in U.S. Pat. No. 5,669,110, the disclosure of which is incorporated herein by reference in its entirety. When a cuff of this type is folded, you must pinch the cross-section of the cuff material (e.g., Nylon) taking strength away from it. By pinching the cross-section, the cross-section is kinked, often making the cuff more difficult to use than if it were not kinked. Hinges introduce a weak spot in the cuff, which defeats the purpose of using the cuff as a restraint. Even when folded, disposable cuffs of the double loop variety are still quite bulky and awkward to carry.

### SUMMARY

The present disclosure solves the problems of the prior art disposable cuffs, by providing an articulated link which allows these cuffs to be rendered both easy to carry and easy to use.

As shown in the prior art discussed above, traditional disposable cuffs have a one-piece head member (a locking socket) and one or more strap members. Once the strap end is properly inserted into the locking socket of the head member, the strap cannot be removed, and the strap must be cut to release the cuff.

In certain embodiments, the one-piece head member of a traditional disposable cuff is separated into two parts, which are joined together to form an articulated and reciprocating linkage. This allows the cuff to be folded in different configurations, and easily carried by the police officer.

In certain embodiments, the cuff of the present disclosure is injection molded and one preferred material is 6-6 nylon with optional strength modifiers. Other plastic materials may likewise be useful herein. In preferred embodiments, the two individual pieces are joined by riveting the protrusion at the head of the cuff opposite one another. Alternatively, other forms of fastening can also be used.

In preferred embodiments, each cuff portion is approximately 18 inches per side, although other sizes are contemplated. For example, in certain embodiments, the cuff can be made longer (e.g., about 18 to about 75 inches per side, more preferably from about 40 to about 60 inches per side), e.g., for easier leg application. In certain embodiments, the cuff can be made smaller (e.g., about 6 to about 18 inches per side, more preferably about 8 to about 12 inches per side), e.g., for a more compact cuff. The exemplary 18-inch size disclosed herein is an intermediate size that works well on both arms and legs of a subject to be restrained.

In certain embodiments, the two cuff portions are joined by a rivet formed of a metal or metal alloy. In preferred embodiments, the rivet is formed of steel or aluminum. In certain embodiments, the rivet is a semi tubular or a solid formation. In alternative embodiments, other forms of fastening the two cuff portions together besides riveting can also be used. In certain embodiments, the two cuff portions are joined using a self-locking external retaining ring on a stud. In certain embodiments, the two cuff portions are joined using nut and bolt fastener components passing through aligned openings in the respective cuff portions. In certain embodiments, the two cuff portions are joined using a screw post. In certain embodiments, the two cuff portions are joined using a molded one-way pin formed on one side of the cuff and a complementary hole or opening formed on the other, the molded pin and opening configured to be joined by pressing them together. In certain embodiments, the two cuff portions are joined using a pivot pin passing through aligned openings in the respective cuff portions having enlarged diameter, e.g., peened, ends.

### BRIEF DESCRIPTION OF THE DRAWINGS

The invention may take form in various components and arrangements of components, and in various steps and arrangements of steps. The drawings are only for purposes of illustrating preferred embodiments and are not to be construed as limiting the invention.

FIG. 1A is an isometric view of a prior art version of a preferred double loop variety of disposable handcuff that can be modified as taught in the present disclosure.

FIGS. 1B and 1E are top and bottom plan views, respectively, of the prior art disposable handcuff appearing in FIG. 1A.

FIGS. 1C and 1D are side and end elevational views, respectively, of the disposable handcuff appearing in FIG. 1A.

FIGS. 2 and 3 show how the double loop handcuff of FIG. 1 can be cut and joined together to form an exemplary embodiment of the articulated double cuff of the present invention.

FIGS. 4 and 7 show exemplary embodiments of the articulated double cuff of the present invention in a preloaded collapsed configuration, for convenient carrying by a police officer.

FIGS. 5 and 8 are fragmentary and full-length views, respectively, of the embodiment appearing in FIGS. 4 and 7, respectively, showing the articulated double cuff in an alternative, non-preloaded, collapsed configuration, for convenient carrying by a police officer.

FIG. 6 is a fragmentary view of the embodiment appearing in FIG. 4, showing the articulated double cuff in a non-preloaded, fully extended configuration.

FIG. 9 illustrates the articulated double cuff embodiment appearing in FIGS. 7 and 8 in a preloaded, fully extended configuration.

FIG. 10 is an isometric view of one strap portion which can be pivotally adjoined with another like strap portion to form an exemplary embodiment of an articulated double cuff of the present invention.

FIGS. 11 and 13 are top and bottom plan views, respectively, of the strap embodiment appearing in FIG. 10.

FIGS. 12 and 14 are side elevational views of the strap embodiment appearing in FIG. 10.

FIG. 15 is an enlarged view of the region A appearing in FIG. 11.

### DETAILED DESCRIPTION OF THE PREFERRED EMBODIMENTS

The terms “a” or “an,” as used herein, are defined as one or more than one. The term “another,” as used herein, is defined as at least a second or more. The terms “including” and/or “having” as used herein, are defined as comprising (i.e., open transition). As used herein, the terms “joined,” “coupled,” “operatively coupled,” and the like, are defined as indirectly or directly connected, unless specifically stated otherwise.

All numbers herein are assumed to be modified by the term “about,” unless stated otherwise. The recitation of numerical ranges by endpoints includes all numbers subsumed within that range (e.g., 1 to 5 includes, inter alia, 1, 1.5, 2, 2.75, 3, 3.80, 4, and 5).

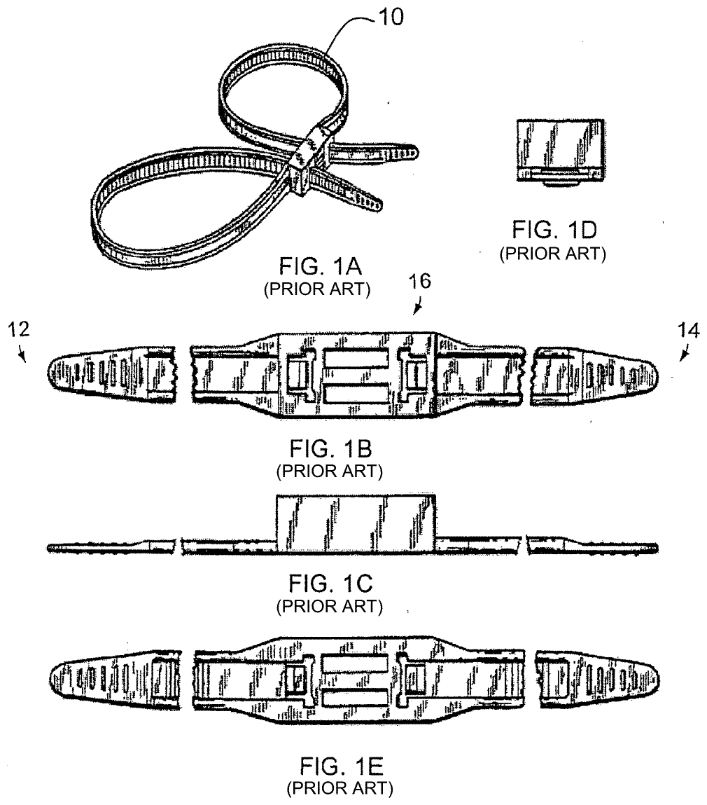

FIGS. 1A-1E show an exemplary prior art version of a disposable double loop handcuff 10, which can be modified as taught in the present disclosure. An exemplary handcuff of this type is the Monadnock-Safariland Double Cuff available from Safariland, LLC, of Jacksonville, Fla. The cuff 10 has two straps 12 and 14 and a central locking head member 16. See also, U.S. Design Pat. No. 347,156, the disclosure of which is incorporated herein by reference in its entirety.

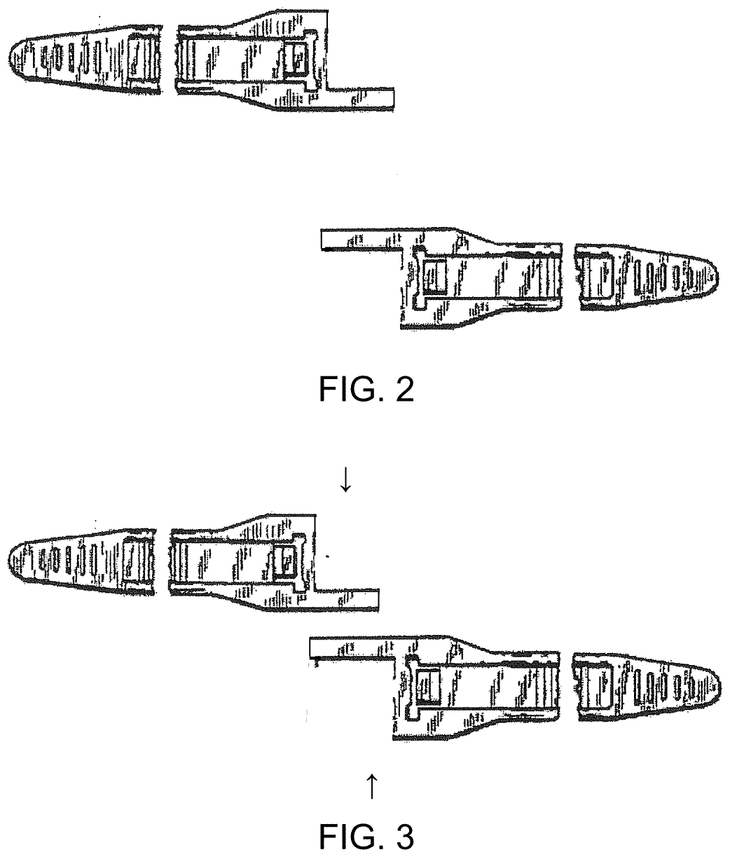

As illustrated in FIGS. 2 and 3, the cuff 10 can be cut apart to form the essential parts of the articulated cuff of the present disclosure; namely two individual semi-rigid toothed straps, each strap including a head member and a tail member, wherein each head member includes a slot with a toothed socket clasp therein; and wherein the two straps are joined together at the head members by an articulating joint.

Thus, one embodiment of the present disclosure is a method for forming an articulated disposable handcuff comprising the steps of:

separating a double loop cuff comprising two elongated straps having a toothed socket clasp located at the midpoint by cutting the clasp to form two individual semi-rigid toothed straps, each strap including a head member and a tail member, wherein each head member includes a slot with a toothed socket clasp therein; and

joining the two straps together at the head members, by creating an articulating joint.

In preferred embodiments, the two elongated straps are substantially flat straps.

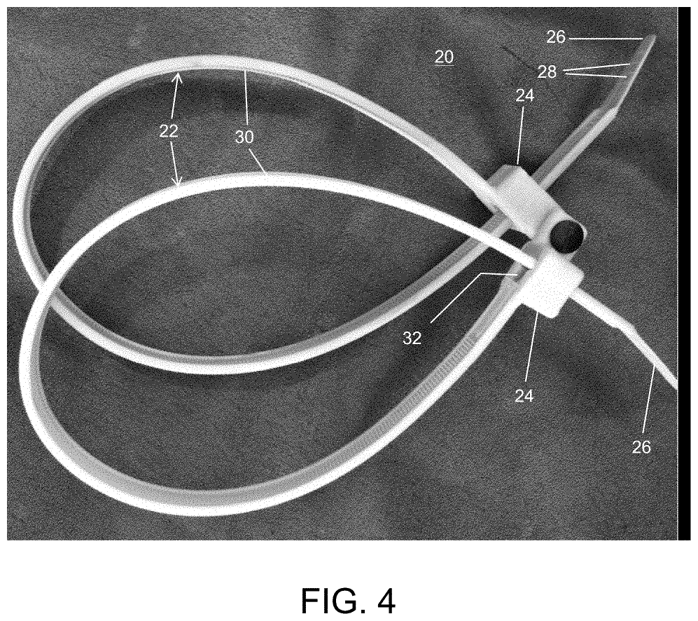

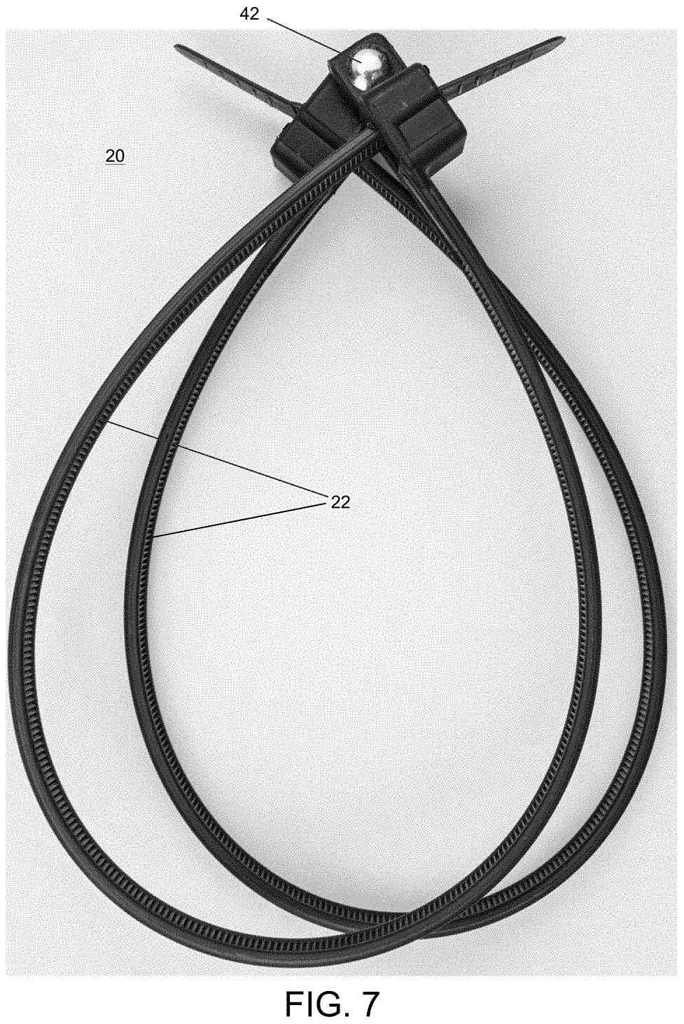

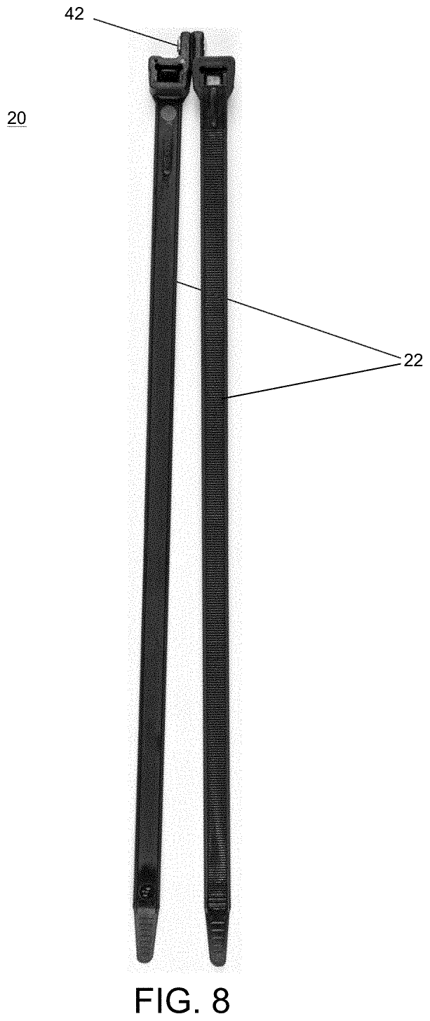

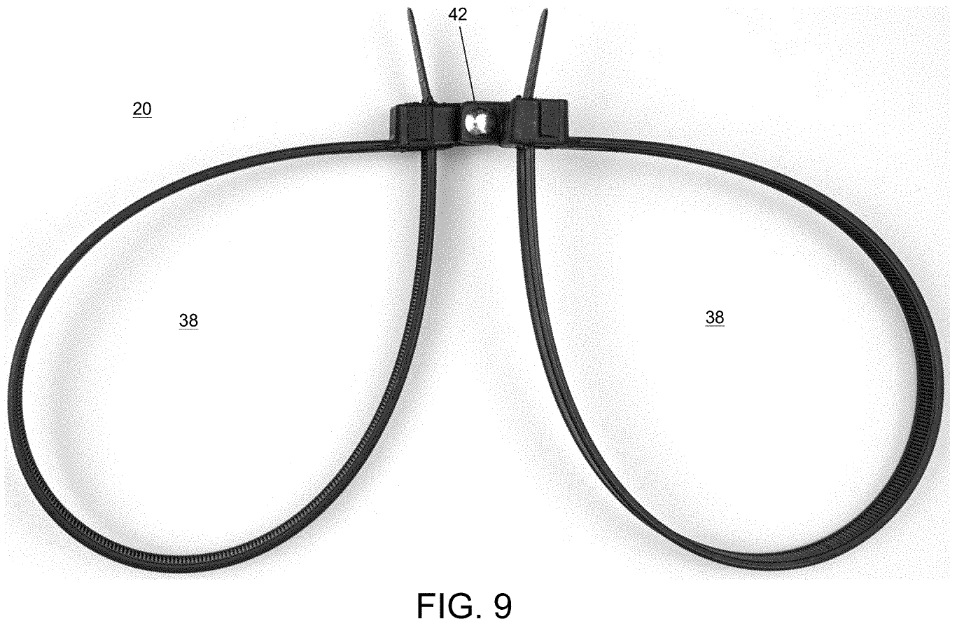

For making commercial quantities of the articulated disposable handcuffs of the present disclosure, molds are formed for making the individual straps, in suitable lengths as required. The heads of two straps are then connected to form the articulated joint, which allows the cuffs to be moved into the positions as shown in FIGS. 4-9.

Thus, another embodiment of the present disclosure provides a method for forming an articulated disposable handcuff comprising the steps of:

providing two elongated, straps having a head member comprising a toothed socket clasp; and

joining the two straps together at the head members, thereby creating an articulating joint.

In preferred embodiments, the two elongated straps are substantially flat straps.

In certain embodiments, the straps are manufactured from ½ inch wide; 3/32 inch thick (minimum) impact-enhanced Nylon 6-6, with a ⅛ inch thick edge. While Nylon polymers are the preferred materials, other types of polymeric materials may likewise be employed. Commercially available strength modifying agents may be employed if desired. The cuffs in accordance with this disclosure, depending upon the materials used, and the size made, can have a high tensile strength, e.g., of at least about 100 psi, 200 psi, 300 psi, 350 psi, or more.

Any strong connector member can be used to form the articulated and reciprocating joint between the two head portions of the straps. The joint is tight enough to hold the straps together, while still permitting the two straps to rotate relative to one another. Steel rods and the like can be used.

As described above, once placed on a detainee's wrist(s) or ankle(s), the cuffs can only be removed by cutting them off. See, for example, the cuff cutter of U.S. Pat. No. 6,532,669, the disclosure of which is incorporated herein by reference in its entirety.

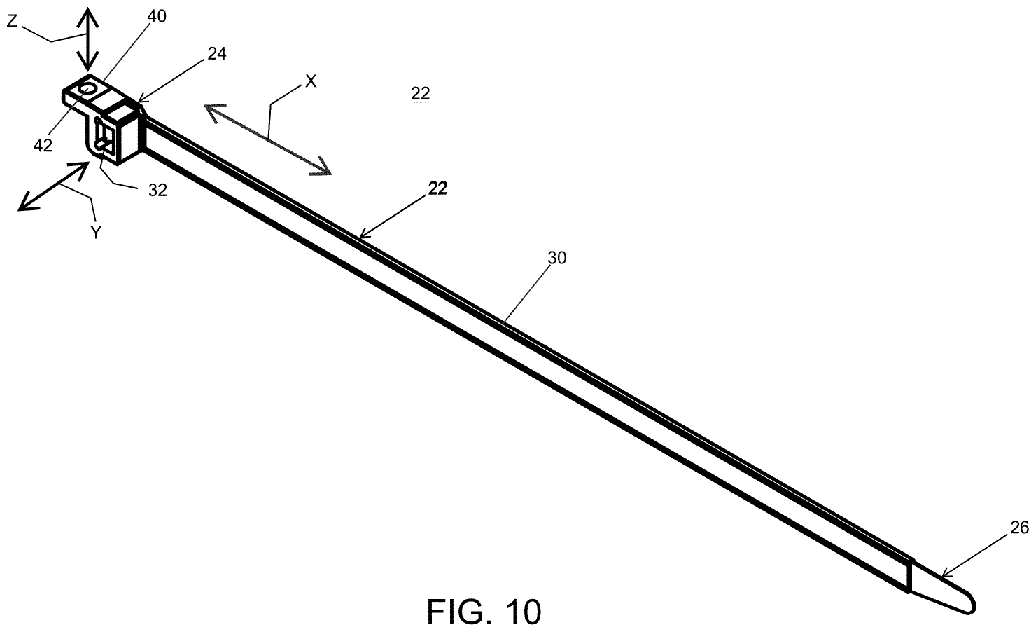

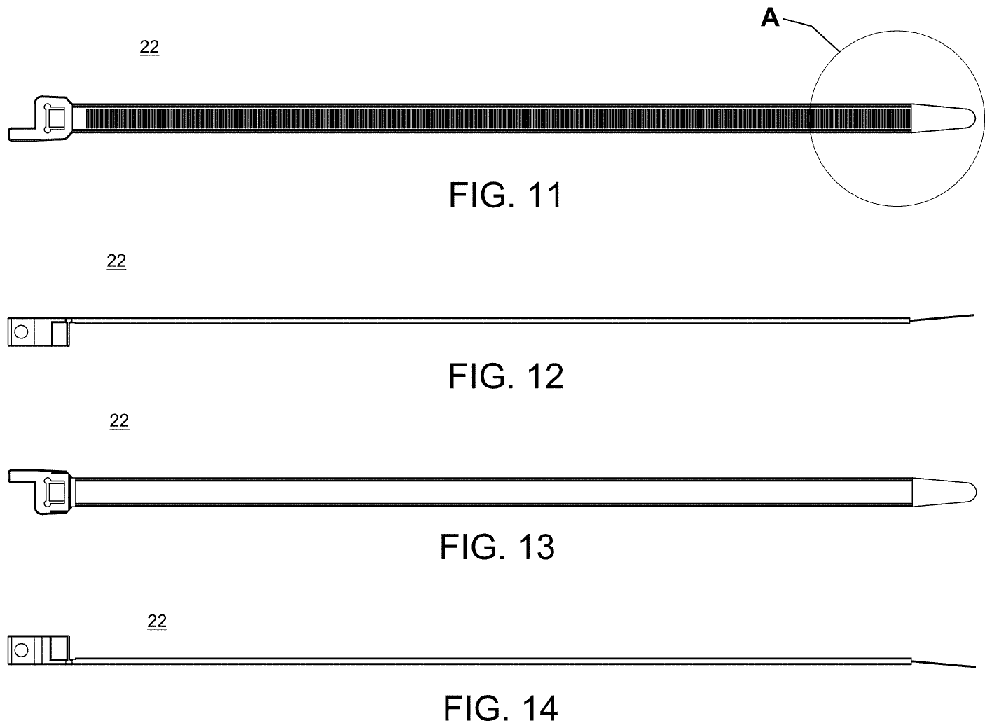

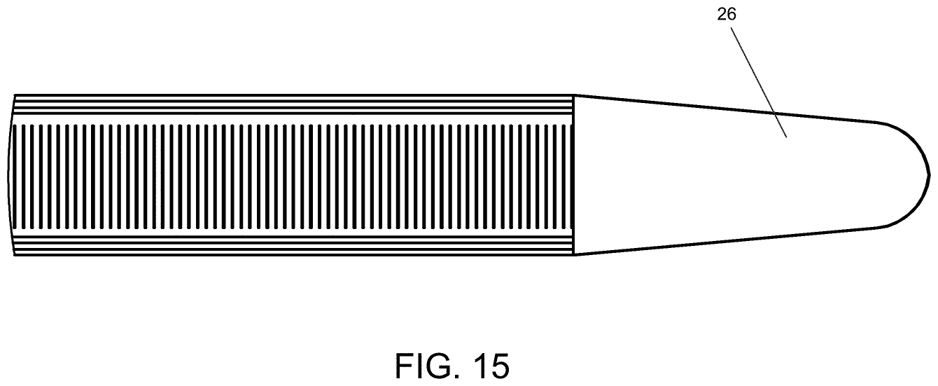

With reference to FIGS. 4-15, a restraint device 20 according to a preferred embodiment of the present disclosure comprises a pair of individual toothed straps 22. Each strap 22 includes a head member 24 disposed at a proximal end thereof and a rounded or tapered tip 26 at a distal end thereof. The tips 26 may include features 28 to provide a high frictional grip, such as ridges, grooves, protrusions, depressions, or the like, to enable manual pulling of the tip during use. An elongated, generally flat strap portion 30 is disposed intermediate the head member 24 and the tip 26. The straps 22 are preferably molded of a strong yet flexible polymer material.

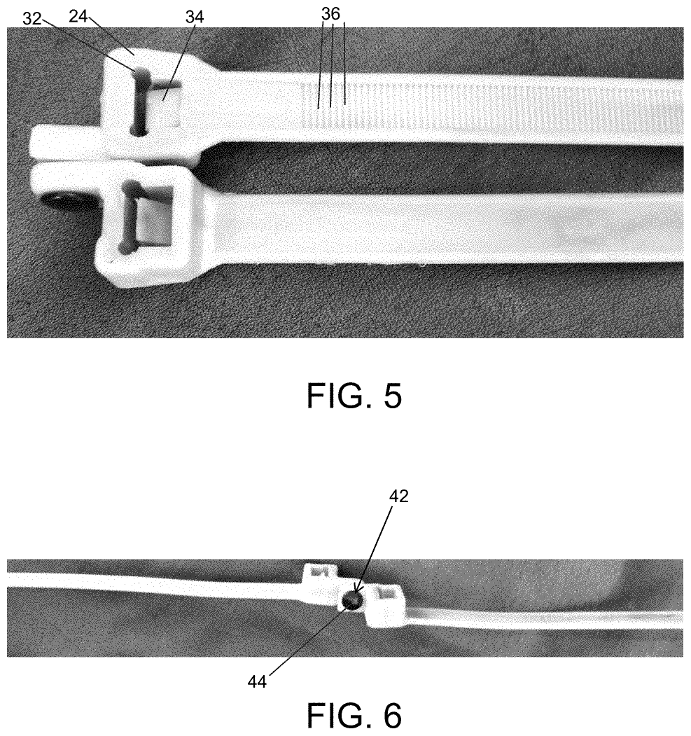

Each head member 24 includes an aperture or slot 32 sized to receive the respective strap portion 30. The slots 32 extends in a direction Y that is generally perpendicular to plane of the major surface of the respective flat strap portion 30 when the strap member 22 is in the elongated or non-looped position (i.e., as shown in FIGS. 5, 6, 8, and 10-14). A tooth or stop 34 projects into the slot. The tooth 34 is configured to engage with an array of serrations or teeth 36, which extend in a transverse direction with respect to a longitudinal axis X of the strap portion 30 when the strap member is in its non-looped configuration (see FIGS. 5, 6, 8, and 10-14). The array of teeth 36 extends along the length of the flat strap portion 30. The teeth 36 may be omitted in the region of the strap portion 30 immediately adjacent the head member 24. In operation, the tip 26 is passed through the slot 32 to form a loop 38, wherein the size of the loop is adjusted by the degree to which the flat strap portion 30 is drawn through the slot 32.

In certain embodiments, the serrations or teeth 36 have a generally saw tooth cross-sectional shape having an abrupt surface and an inclined surface. The tooth or stop 34 likewise has an inclined surface, such that the inclined surface of the teeth 36 and the inclined surface of the tooth 36 will slide past each other when the flat strap portion 30 is pulled through the slot 32 in a direction that causes a tightening of the loop 38. Conversely, when it is attempted to move the strap portion 30 relative to the slot 32 in a direction that would increase the size of the loop 38, the tooth 34 engages the abrupt surface of the tooth 36, thereby resisting any loosening or enlarging of the loop 38.

The head member 24 further includes a projection 40, which extends from the head member 24 in a direction opposite the flat scrap portion 30. In certain embodiments, the projection 40 is generally flat or planar projection. An opening or bore 42 extends through the projection 40. In certain embodiments, the bore 42 extends in a direction Z that is generally perpendicular to the direction Y of the slot 32, such that the directions X, Y, and Z are generally mutually orthogonal.

To manufacture the restraint device 20, two individual toothed straps 22 are positioned adjacent to each other such that the respective projections 40 are adjacent with the respective bores 42 aligned. A pivot pin 44 is passed through the bores 42 to secure the two straps 22 together in a manner that allows pivoting movement therebetween. In certain embodiments, the pivot pin 44 includes enlarged diameter ends for retaining the pivot pin within the apertures 42.

The invention has been described with reference to the preferred embodiments. Modifications and alterations will occur to others upon a reading and understanding of the preceding detailed description. It is intended that the invention be construed as including all such modifications and alterations insofar as they come within the scope of the appended claims or the equivalents thereof.

What is claimed is:

1. A disposable handcuff comprising two individual semi-rigid toothed straps, each strap including a head member and a tail member, wherein each head member includes a slot with a toothed socket clasp therein; and wherein the two straps are joined together at the head members by an articulating joint.

2. The disposable handcuff of claim 1, wherein the semi-rigid toothed straps comprise Nylon.

3. The disposable handcuff of claim 2, wherein the Nylon is selected from the group consisting of Nylon 6-6 and impact-enhanced Nylon 6-6.

4. The disposable handcuff of claim 3, wherein the Nylon has a tensile strength of at least about 100 psi.

5. The disposable handcuff of claim 1, wherein a length of each strap ranges from about 18 inches to about 40 inches.

6. A method for forming an articulated disposable handcuff comprising the steps of:
separating a double loop cuff comprising two elongated straps having a toothed socket clasp located at a midpoint by cutting the clasp to form two individual semi-rigid toothed straps, each strap including a head member and a tail member, wherein each head member includes a slot with a toothed socket clasp therein; and
joining the two straps together at the head members, thereby creating an articulating joint.

7. The method of claim 6, wherein the semi-rigid toothed straps comprise Nylon.

8. The method of claim 7, wherein the Nylon is selected from the group consisting of Nylon 6-6 and impact-enhanced Nylon 6-6.

9. The method of claim 8, wherein the Nylon has a tensile strength of at least about 100 psi.

10. The method of claim 6, wherein a length of each strap ranges from about 24 inches to about 60 inches.

11. A method for forming an articulated disposable handcuff comprising the steps of:
providing two elongated straps having a head member comprising a toothed socket clasp; and
joining the two straps together at the head members, thereby creating an articulating joint.

12. The method of claim 11, wherein the semi-rigid toothed straps comprise Nylon.

13. The method of claim 12, wherein the Nylon is selected from the group consisting of Nylon 6-6 and impact-enhanced Nylon 6-6.

14. The method of claim 13, wherein the Nylon has a tensile strength of at least about 100 psi.

15. The method of claim 11, wherein a length of each strap ranges from about 24 inches to about 60 inches.
